(19) United States
(12) Patent Application Publication
(10) Pub. No.: US 2014/0006978 A1
(43) Pub. Date: Jan. 2, 2014

(54) Intelligent browser for media editing applications

(71) Applicant: Kenneth Meehan, Redwood City, CA (US)

(72) Inventor: Kenneth Meehan, Redwood City, CA (US)

(73) Assignee: Apple Inc., Cupertino, CA (US)

(21) Appl. No.: 13/539,429

(22) Filed: Jun. 30, 2012

(51) Int. Cl. G06F 3/01

(52) U.S. Cl. 715/760

(57) ABSTRACT

A browser for a media editing application provides simultaneous access to multiple categories of media. The user can drag the edge of a media browser to create a new window, which can then be populated with a new category of media content. The user can identify and select multiple items of content at one time, and move them to the timeline tracks in conjunction with one another. The different media windows can be associated with corresponding tracks, or roles, in the timeline. If the user selects media from multiple windows simultaneously, they can be added to the timeline as one group, with each item of content being positioned within its corresponding track or role of the timeline.

### FIELD

The present disclosure generally relates to media editing tools, and more particularly to the user's ability to assemble multiple items of media content to create a media project.

Media editing application programs enable users to manipulate media files in a variety of different ways to create a desired result. For example, with a video editing application, the user can trim, splice, cut and arrange multiple video clips along a timeline, to create a sequence of scenes. Furthermore, the user can add one or more video and/or audio tracks to the main storyline sequence, to create a multi-media presentation. Similar types of operations can be performed with respect to audio files, e.g. one or more auxiliary tracks can be added to the main track, to provide background audio, sound effects, etc.

In the assembly of media content to create a project, such as a video presentation, different timeline tracks, or roles, are employed for different respective kinds of content. For instance, a video production of an interview may utilize a main video track that contains video of the person being interviewed, and a main audio track that contains the dialogue. A secondary video track might be employed for alternate footage that is used for cutaway shots, such as views of the interviewer and scenes that are relevant to the topic of the interview. Similarly, one or more secondary audio tracks may be employed for background music or sound effects. The production is assembled by selecting various items of media content from a browser, and placing them at appropriate points in time on the track associated with that content.

Typically, the browser limits the user to one category of media content at a time, for selection. For example, in response to entry of one keyword, the browser may display all of the video clips that relate to the interview, and by entering another keyword, the user can bring up the video clips that pertain to cutaway shots. However, the presentation of these different forms of content in isolation disconnects the user from possible editing combinations. It may be preferable for the user to view the interview clips while simultaneously viewing the available cutaway shots. If the user is able to view multiple groups of media simultaneously, he or she may be able to more readily conceptualize complementary relationships that better communicate the story.

It may be possible to merge keywords, so that multiple groups of content are mixed together in the browser. However, such a presentation dilutes the organization of the content, and disconnects the user from the media. If the user is able to separately display multiple categories of content, he or she may be able to make better preliminary editing decisions.

### SUMMARY

In accordance with the present disclosure, a browser for a media editing application is described that provides simultaneous access to multiple categories of media. In one embodiment, the user can drag the edge of a media browser to create a new window, which can then be populated with a new category of media content. Preferably, as one window is enlarged, other windows of the user interface automatically resize themselves, to maintain a manageable presentation of information while providing a greater view of the media content. By means of such a presentation, the user can identify and select multiple items of content at one time, e.g. an interview clip and a cutaway clip, and move them to the timeline tracks in conjunction with one another.

In another embodiment, the different media windows can be associated with corresponding tracks, or roles, in the timeline. If the user selects media from multiple windows simultaneously, they can be added to the timeline as one group, with each item of content being positioned within its corresponding track or role of the timeline. As a result, the timeline remains better organized, and the assembly process is made easier.

Further features of the media editing user interface, and the advantages provided thereby, are described hereinafter with reference to exemplary embodiments illustrated in the accompanying drawings.

### BRIEF DESCRIPTION OF THE DRAWINGS

FIG. 1 is an illustration of an exemplary user interface for a video editing application;

FIG. 2 is an enlarged view of an exemplary timeline;

FIG. 3 is an illustration of a first embodiment of a user interface having multiple browser windows;

FIG. 4 is an illustration of a second embodiment of a user interface having multiple browser windows;

FIG. 5 is an illustration of a menu for assigning an assembly preference to a browser window;

FIG. 6 is a block diagram of the components of an exemplary computing device in which the user interface can be implemented; and

FIG. 7 is a flowchart of an exemplary algorithm for implementing the disclosed features of the user interface.

### DETAILED DESCRIPTION

To facilitate an understanding of the principles that underlie the invention, it is described hereinafter with reference to exemplary embodiments of its application to a video editing program. It will be appreciated that the practical implementations of the invention are not limited to the described examples. Rather, the concepts described herein can be applied in a variety of different types of media editing applications, such as audio editing programs and music creating programs.

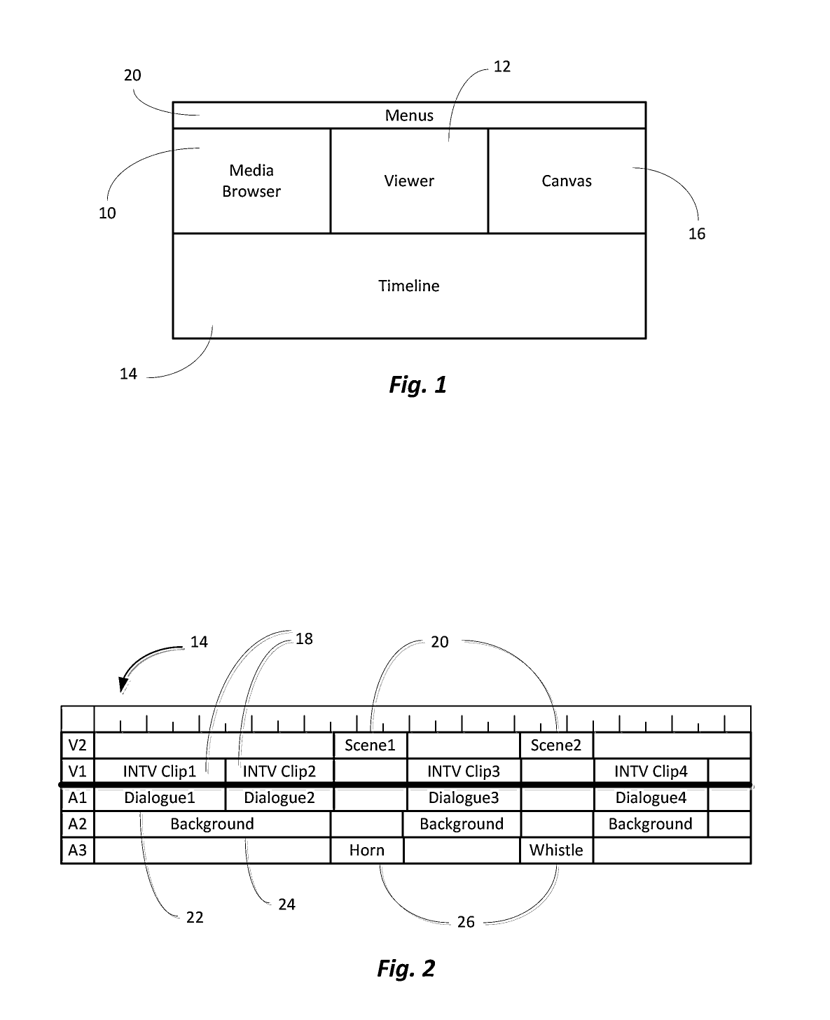

FIG. 1 illustrates an example of a user interface for a video editing application in which a multi-window browser can be implemented, in accordance with the present disclosure. The interface includes a number of windows, including a media browser 10, a viewer 12, a timeline 14 and a canvas 16. The media browser 10 contains media clips that are available to incorporate into a movie, or other video sequence being edited. The viewer 12 displays a selected clip from those presented in the browser 10. Editing operations on that clip are depicted in the viewer as the user makes changes to the clip. The timeline 14 holds the sequence of video and audio clips, in the order in which the user has assembled them to create a video project. The timeline can also contain other items, such as titles and transitions, at designated points in the sequence. The canvas 16 is the area in which the movie created in the timeline 14 can be played back for viewing.

FIG. 2 is an enlarged view of the timeline 14. In the illustrated example, the timeline contains two video tracks, and three audio tracks. The primary video track, V1, contains the video clips 18 that constitute the main storyline. In the case of an interview, for example, these clips might contain the video images of the person be interviewed, and perhaps also the interviewer. A second video track, V2, is located above the primary track V1, and contains cutaway shots 20 that are used in the video sequence. For example, the cutaway shots may include images and/or scenes that pertain to the topic of the interview.

The primary audio track, A1, contains the principle sounds 22 that pertain to the storyline, e.g., the dialogue between the interviewer and interviewee. A second audio track, A2, might contain background sounds 24, such as the background music in a movie. A third audio track, A3, might contain sound effects 26, and/or sounds that are associated with the cutaway shots.

During the assembly of an audio video sequence, the user selects appropriate video or audio clips from the browser 10, and drags them to the timeline 14. Typically, the clips are automatically placed within the primary video or audio track of the timeline. If those clips pertain to other portions of the sequence, the user can vertically move them to the appropriate track. Thus, cutaway shots would be moved from their initial placement in the primary track V1 to the secondary track V2. Similarly, background music and sound effects are moved from the primary audio track, A1, to the appropriate secondary tracks A2 or A3. In addition to placing the respective clips in the appropriate tracks, the user can also adjust their horizontal position along the timeline, so that they are played back in the proper sequence, relative to one another.

Typically, the video and audio clips are organized by content in a media library, and can be stored in associated containers, e.g. folders or bins, that correspond to different categories of content. In another embodiment, the clips may be tagged with one or more keywords that pertain to their content. Thus, for example, the set of clips that are taken at an interview might be identified with the keywords “Storyline,” “Jones Interview,” or the like. The clips of various scenes and images that form the cutaway shots might have different keywords such as “Childhood Home,” “College Years,” “Campaign,” and the like. In a similar manner, the various audio clips can be categorized according to their content, such as “Dialogue,” “Background Music,” “Sound Effects,” and the like. Based on the keywords, various keyword collections can be formed in the media library. When the user selects a particular keyword collection, each clip tagged with that keyword is displayed in the browser.

Conventionally, only one category of information is presented in the browser 10 at a time. Thus, for example, if the user enters the keyword “Interview,” the video clips corresponding to that content are displayed in the browser. The user may select certain ones of those clips and place them in the timeline, and then enter a new keyword, e.g., “Campaign,” to select certain cutaway shots. Upon entry of the new keyword, the video clips associated with the keyword “Interview” are replaced by the video clips associated with the keyword “Campaign.” Thus, the user must go through the process of selecting individual clips of a particular type, placing them in the timeline, selecting clips of another type, place those in the timeline, and then adjust the relative positions of the various clips to achieve the desired result.

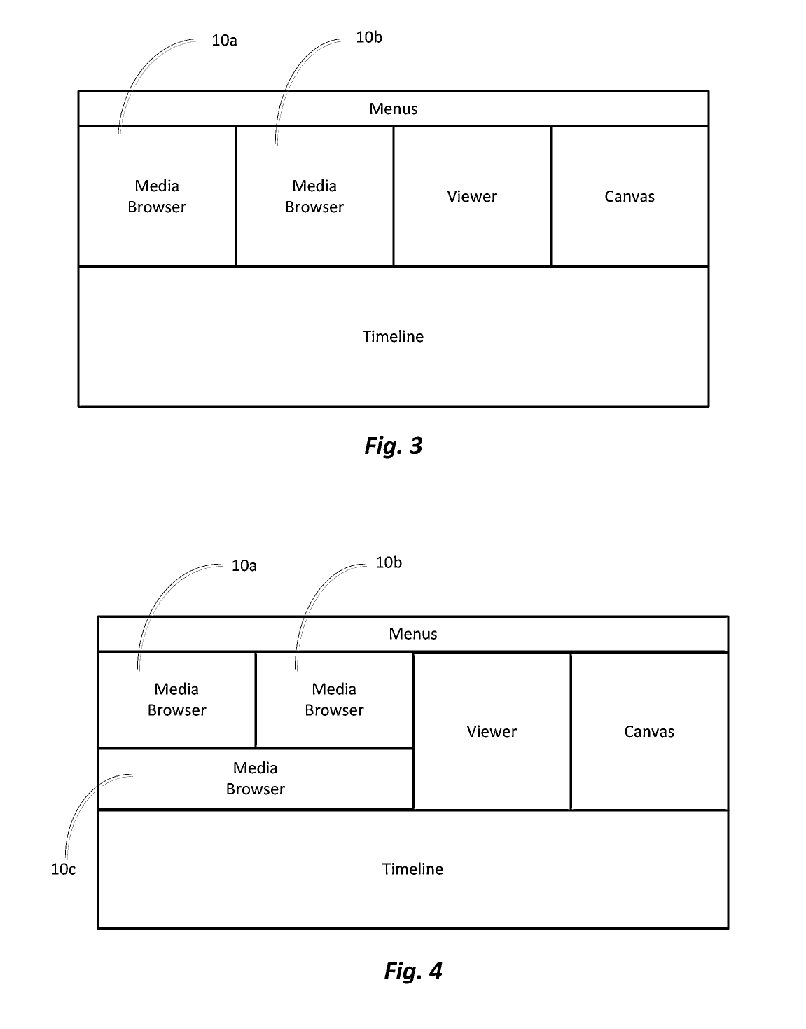

In accordance with one embodiment of the present disclosure, the user interface for a media editing application provides multiple browser windows, to enable the user to view, and select, different categories of media content at the same time, while maintaining a distinction between the individual categories of media. In one implementation, the user can drag one edge of the browser 10, to create a new window. An example of this feature is illustrated in FIG. 3. Referring thereto, the user interface contains two browser windows 10a and 10b. The browser 10a may correspond to the original browser 10 of FIG. 1, and the browser window 10b is created when the user drags the right edge of the browser 10 to the right. Rather than enlarging the window of the browser 10, this dragging action results in the creation of a new window. When the new window is created, the other windows of the user interface automatically resize themselves to maintain an organized presentation of the media information, while providing a greater view of the media clips.

Once the new browser window 10b is created, it can be associated with a media category that is different from the category currently associated with the original browser window 10a. For example, if the keyword “Storyline” was used to select the video clips displayed in the browser window 10a, upon creation of the second browser window 10b, the user might enter the keyword “Campaign.” As a result, a different set of video clips, which are associated with that keyword, are displayed in the browser window 10b. By means of such presentation, the user is able to conceptualize the different categories of media content in conjunction with one another. For example, from the first browser window 10a, containing clips associated with the main storyline, the user might select a clip in which the interviewee is discussing a campaign in which she was engaged. At the same time, the user can select one or more clips from the second browser window 10b, to use as cutaway shots that depict images of the campaign. Thus, a clip can be selected in each of the browser windows 10a and 10b, and dragged to the timeline simultaneously. By means of such an operation, the two related clips are placed on the timeline in conjunction with one another, which makes it easier for the user to visualize their relationship and position them relative to one another, before adding another clip that pertains to the main storyline.

The user interface is not limited to the presentation of two browser windows. Rather, any suitable number of browser windows can be created that is consistent with the organized presentation of information in the user interface. For instance, FIG. 4 illustrates an example of a user interface in which a third browser window 10c is displayed beneath the two browser windows 10a and 10b. In this case, the third browser window might be created by dragging the bottom edge of either of the windows 10a or 10b in a downward direction. In response to such an action, the height of each of the two browser windows 10a and 10b might be reduced, to make room for the new browser window.

Other arrangements for accommodating additional browser windows are also possible. For example, if an additional browser window is created to the right side of the window 10b, it would impinge upon the space occupied by the viewer 12 and the canvas 16. To accommodate the new browser window, the viewer window 12 could slide to the right, on top of the canvas window 16. The user could then toggle between the viewer and canvas windows, as desired, for example by clicking on tabs associated with the respective windows.

In accordance with another embodiment, a browser window can have an assembly preference associated with it, which pertains to its placement in the timeline. As discussed previously, when a media clip is dragged from a browser window to the timeline, it is typically placed in the primary track associated with its type of content. Thus, a video clip is placed in track V1, and an audio clip is placed in audio track A1. From these primary tracks, the user then vertically moves the clip to a different track, if appropriate. By associating a particular assembly preference with a browser window, the need to realign placed clips at the appropriate vertical position in the timeline can be avoided.

For example, the video track that is employed for cutaway shots is often designated as the “B-roll” track. By associating a browser window with the B-roll functionality, whenever a video clip is dragged from that window to the timeline, it is automatically placed in the B-roll track, e.g., track V2. As a result, the user's effort to assemble the video sequence is lessened.

In the foregoing examples of the user interface, the timeline is described in connection with individual tracks that are employed to distinguish the different types of media clips from one another. In some embodiments of media editing programs, the media clips are identified in the timeline in accordance with the respective roles that they perform within the media project. For example, the different roles, such as sound effects, titles, background music, etc., can be designated by color coding. Alternatively, or in addition, vertical positioning within the timeline might be used to identify the roles, in a manner analogous to tracks. The disclosed principles are equally applicable to these embodiments of media editing applications, as well as those which employ tracks in the timeline. In other words, a particular browser window can be associated with a specific role, such that media content dragged from that browser window to the timeline is placed at the proper vertical position, in accordance with its associated role.

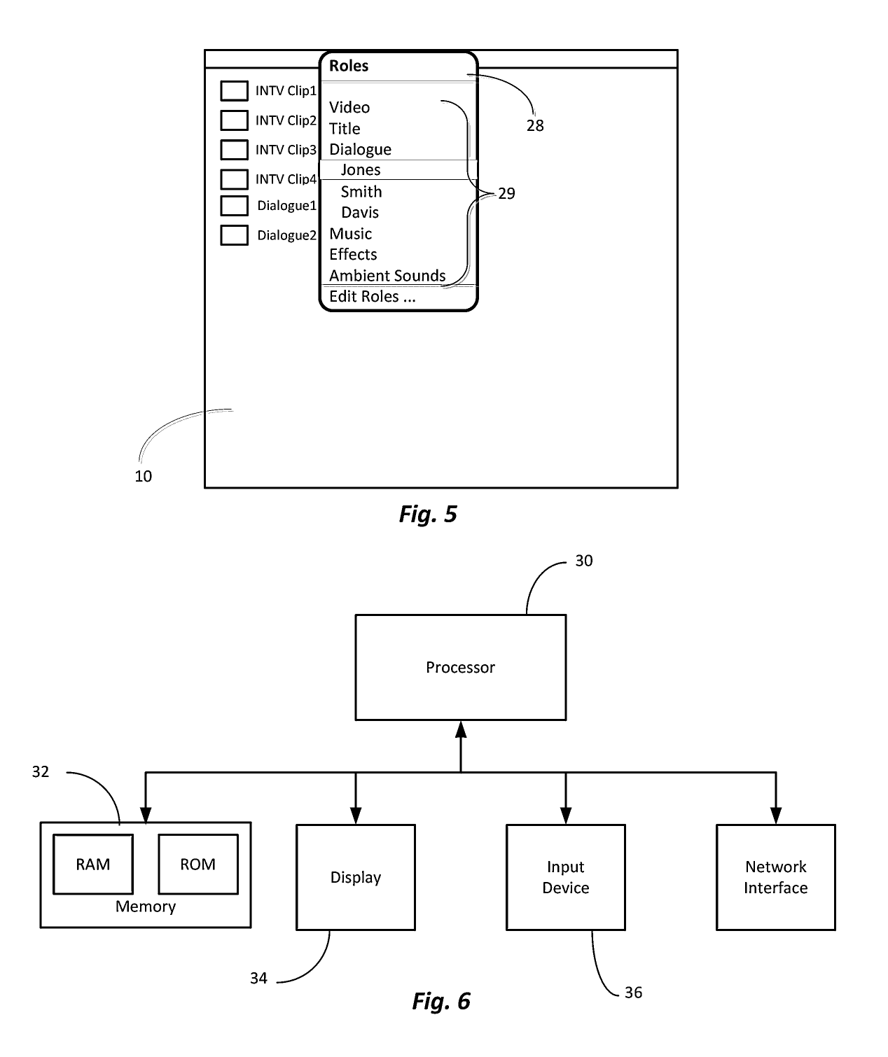

FIG. 5 illustrates an example of one manner in which the user can associate an assembly preference with a browser window. By entering a suitable command, e.g. a right- or control-click while a cursor is positioned over the browser window 10, a drop-down menu 28 can appear. The menu presents a selection of available roles 29 that can be assigned to the browser window. In the illustrated example, the user has selected the “Jones” subrole under the main “Dialogue” role for that browser window. Thereafter, when the user drags a clip from that browser window to the timeline, it is automatically placed on the track associated with the Jones dialog. In a video editing application that employs roles to assemble clips in the timeline, in lieu of tracks, the clip is placed with an appropriate indication of its assigned role, e.g. color coding, vertical position, etc. Each browser window can have a corresponding menu of this type, for individual association with a respective role.

The association of browser windows with different assembly preferences is particularly effective when multiple browser windows are employed. If multiple selections of media content are made in multiple windows at the same time, they are added to the timeline in one group, as discussed previously. In addition, they are automatically placed in the correct respective tracks, or roles, in vertical alignment with one another. Thus, for example, if the user selects media in an “Interview” “B-roll,” and “Music” windows, and adds them to the timeline, they would be placed in their respective tracks and vertically stacked upon one another. The editor would then only need to adjust their various transition points, to provide the desired synchronization between them. Thus, the association of browser windows with respective roles in the timeline enables the user's assembly preferences to be established before any media is added to the project. As such, the assembly process becomes semi-automated.

FIG. 5 is a block diagram of the general structure of a computing device in which a video editing application having multiple browsers can be implemented, in accordance with the present disclosure. The computing device includes a processor 30 operatively connected to one or more forms of computer-readable storage media 32, e.g. RAM, ROM, flash memory, optical and/or magnetic disk drives, etc. The storage media can be integral with the computing device, attachable to the computing device, e.g., a flash drive, or accessible via a wired or wireless network. The processor is also connected to a display device 34 and an input device 36 in some forms of computing devices, the display device and the input device could be integrated, e.g., a touch screen, whereas in other they may be separate components, e.g., a monitor, a keyboard and a mouse.

The program instructions to implement the user interface described herein are preferably stored in a non-volatile form of memory, such as ROM, flash drive, disk drive, etc., and loaded into RAM for execution. The video and audio clips 18-26 that are imported into the media browser 10, for use in the creation of a video production, as well as the project file that contains the end result of the editing project, can be stored in the same non-volatile memory as the video editing application program, or in separate memory that is accessible via the computing device.

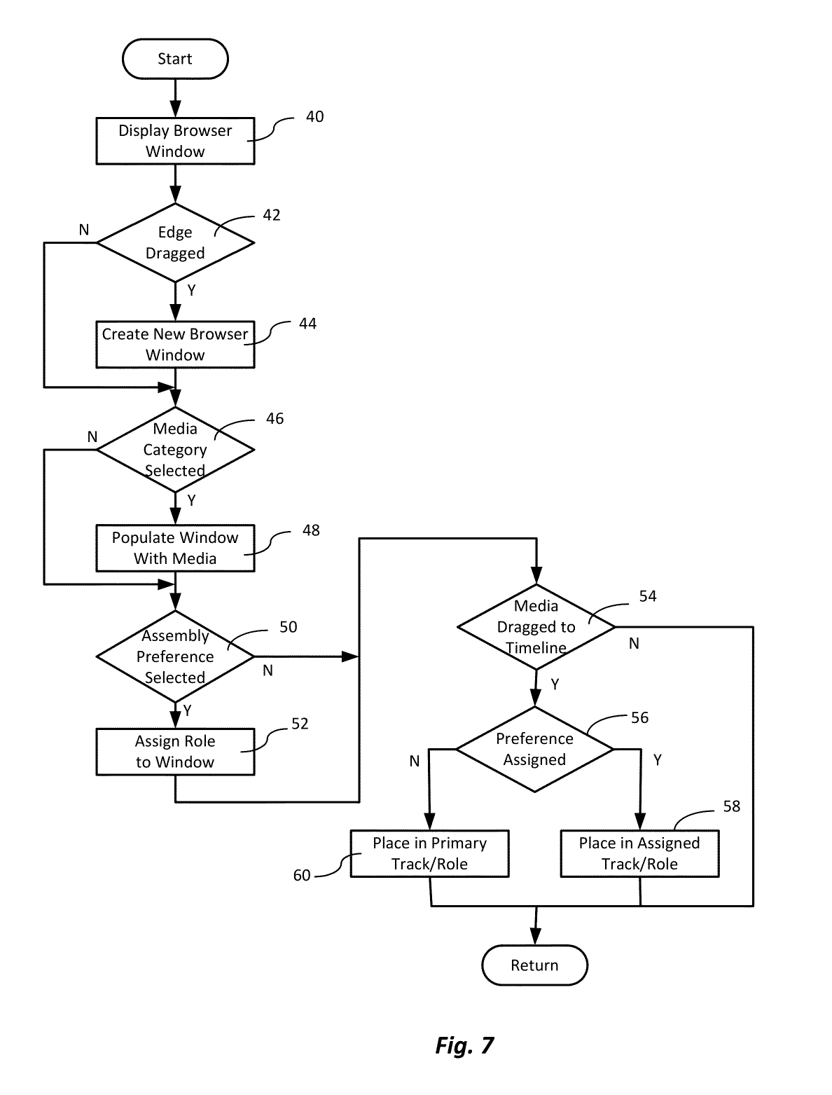

FIG. 7 is a flowchart of an exemplary algorithm that can be executed by the processor to implement the functionality of the user interface. After the media editing program is launched, it displays the media browser window at step 40. Thereafter, at step 42, the processor detects whether an edge of the browser window is being dragged. If so, a new browser window is created at step 44. After the window is created, or if no dragging was detected, the processor determines at step 46 whether a category of media has been designated for any of the displayed browser windows, e.g. by selecting a keyword. If so, the browser window is populated with the media in that category, at step 48. In step 50, the processor determines whether an assembly preference has been selected for any displayed browser window. If so, the role corresponding to that selection is assigned to the window at step 52.

Thereafter, a detection is made at step 54 whether an item of media content, e.g. a video or audio clip, is being dragged from a browser window to the timeline. If so, a determination is made at step 56 whether that window has an assembly preference assigned to it. If so, the dragged item of content is placed in the timeline at the track or role that corresponds to the assigned assembly preference for that window, at step 58. Conversely, if no assembly preference has been assigned to the browser window, the dragged item of content is placed in the primary video or audio track, or role, depending upon whether it is a video or audio clip.

If no dragging of media content is detected at step 54, the processor returns to its main routine, until the next time one of the actions depicted in steps 42, 46, 50 or 54 is detected. Likewise, after placing an item of media content in the timeline at one of steps 58 or 60, the processor returns to its main routine until one of the noted actions is again detected.

From the foregoing, it can be seen that the disclosed user interface enhances the user's ability to create and edit media projects. Through the ability to view multiple categories of media via multiple respective browser windows, the editor can conceptualize complementary relationships of the different categories of media that communicate the story, for example, by associating appropriate cutaway shots with principle storyline clips. In addition, the ability to simultaneously drag multiple different categories of media to the timeline maintains the organization of the clips within the timeline, and reduces the amount of time needed to construct a scene. Moreover, the association of browser windows with specific timeline tracks, or roles, further reduces the construction time, and enhances the organization of the media in the timeline, by aligning added items of content with one another.

It will be appreciated by those of ordinary skill in the art that the disclosed media editing user interface can be embodied in other specific forms, without departing from the spirit or essential characteristics thereof. As noted previously, in addition to the described video editing application, it can be used in conjunction with audio editing, and other media manipulation projects. The presently disclosed embodiments are therefore considered in all respects to be illustrative, and not restrictive. The scope of the invention is indicated by the appended claims, rather than the foregoing description, and all changes that come within the meaning and range of equivalents thereof are intended to be embraced therein.

What is claimed is:

1. A media editing system, comprising:
a display device;
memory for storing data for use in a media project, the data comprising a plurality of different respective categories of media content; and
a processor that is configured to perform the following operations:
display a user interface on said display device, the user interface including a first browser window that presents a first category of media content that a user can select to incorporate into a media project,
in response to a user input, display a second browser window in the user interface; and
display a second, different category of media content in the second browser window, simultaneously with the first category of media content displayed in the first browser window, for a user to select and incorporate into the media project.

2. The media editing system of claim 1, wherein the user interface enables an item of media content displayed in the first browser window and an item of media content displayed in the second browser window to be concurrently selected by the user, and incorporated into the media project simultaneously.

3. The media editing system of claim 1, wherein the user input comprises dragging an edge of the first browser window.

4. The media editing system of claim 1, wherein the processor is further configured to:
receive a user designation of an assembly preference, and assign the designated assembly preference to a displayed browser window;
determine whether a user command, to incorporate an item of media content into the media project, pertains to an item that is displayed in the browser window having the assigned assembly preference; and
if the item is displayed in the browser window having the assigned assembly preference, incorporate the item into the media project with an indication of the designated assembly preference.

5. The media editing system of claim 4, wherein the indication of the designated assembly preference comprises color coding of the item of media content in a timeline of the user interface.

6. The media editing system of claim 4, wherein the indication of the designated assembly preference comprises placement of the item of media content at a vertical position in a timeline of the user interface that corresponds to the designated assembly preference.

7. The media editing system of claim 4, wherein the indication of the designated assembly preference comprises placement of the item of media content in a track of a timeline in the user interface that corresponds to the designated assembly preference.

8. The media editing system of claim 4, wherein the user interface enables different respective assembly preferences to be assigned to the first and second browser windows.

9. The media editing system of claim 8, wherein the user interface enables an item of media content displayed in the first browser window and an item of media content displayed in the second browser window to be concurrently selected by the user, and simultaneously incorporated into the media project in accordance with the respective assigned assembly preferences.

10. A media editing system, comprising:
a display device;
memory for storing data for use in a media project, the data including media content; and
a processor that is configured to perform the following operations:
display a user interface on said display device, the user interface including a browser window that presents media content that a user can select to incorporate into a media project,
receive a user designation of an assembly preference, and assign the designated assembly preference to a displayed browser window,
determine whether a user command, to incorporate an item of media content into the media project, pertains to an item that is displayed in the browser window having the assigned assembly preference, and
if the item is displayed in the browser window having the assigned assembly preference, incorporate the item into the media project with an indication of the designated assembly preference.

11. The media editing system of claim 10, wherein the indication of the designated assembly preference comprises color coding of the item of media content in a timeline of the user interface.

12. The media editing system of claim 10, wherein the indication of the designated assembly preference comprises placement of the item of media content at a vertical position in a timeline of the user interface that corresponds to the designated assembly preference.

13. The media editing system of claim 10, wherein the indication of the designated assembly preference comprises placement of the item of media content in a track of a timeline in the user interface that corresponds to the designated assembly preference.

14. A computer-readable medium having stored thereon program instructions which, when executed by a processor, cause the processor to perform the following operations:
display a user interface for a media editing program on a display device, the user interface including a first browser window that presents a first category of media content that a user can select to incorporate into a media project,
in response to a user input, display a second browser window in the user interface; and
display a second, different category of media content in the second browser window, simultaneously with the first category of media content displayed in the first browser window, for a user to select and incorporate into the media project.

15. The computer-readable medium of claim 14, wherein the user interface enables an item of media content displayed in the first browser window and an item of media content displayed in the second browser window to be concurrently selected by the user, and incorporated into the media project simultaneously.

16. The computer-readable medium of claim 14, wherein the program instructions further cause the processor to:
receive a user designation of an assembly preference, and assign the designated assembly preference to a displayed browser window;
determine whether a user command, to incorporate an item of media content into the media project, pertains to an item that is displayed in the browser window having the assigned assembly preference; and
if the item is displayed in the browser window having the assigned assembly preference, incorporate the item into the media project with an indication of the designated assembly preference.

17. The computer-readable medium of claim 16, wherein the user interface enables different respective assembly preferences to be assigned to the first and second browser windows.

18. A method for facilitating the creation and editing of media projects, comprising:
displaying a user interface for a media editing program on a display device, the user interface including a first browser window that presents a first category of media content that a user can select to incorporate into a media project,
in response to a user input, displaying a second browser window in the user interface; and
displaying a second, different category of media content in the second browser window, simultaneously with the first category of media content displayed in the first browser window, for a user to select and incorporate into the media project.

19. The method of claim 18, wherein the user interface enables an item of media content displayed in the first browser window and an item of media content displayed in the second browser window to be concurrently selected by the user, and incorporated into the media project simultaneously.

20. The method of claim 18, further comprising:
receiving a user designation of an assembly preference, and assigning the designated assembly preference to a displayed browser window;
determining whether a user command, to incorporate an item of media content into the media project, pertains to an item that is displayed in the browser window having the assigned assembly preference; and
if the item is displayed in the browser window having the assigned assembly preference, incorporating the item into the media project with an indication of the designated assembly preference.

21. The method of claim 20, wherein the user interface enables different respective assembly preferences to be assigned to the first and second browser windows.

22. A method for facilitating the creation and editing of media projects, comprising:
displaying a user interface for a media editing program on a display device, the user interface including a browser window that presents media content that a user can select to incorporate into a media project;
receive a user designation of an assembly preference, and assign the designated assembly preference to a displayed browser window;
determine whether a user command, to incorporate an item of media content into the media project, pertains to an item that is displayed in the browser window having the assigned assembly preference; and
if the item is displayed in the browser window having the assigned assembly preference, incorporate the item into the media project with an indication of the designated assembly preference.
